(19) United States
(12) Patent Application Publication
(10) Pub. No.: US 2014/0115103 A1
(43) Pub. Date: Apr. 24, 2014

(54) MESSAGE INTEROPERABILITY BETWEEN PLATFORMS

(71) Applicants: Christopher Kenneth Holmes, Ashtead (GB); Julian Frazier Ewart Johnson, Blackburn (GB)

(72) Inventors: Christopher Kenneth Holmes, Ashtead (GB); Julian Frazier Ewart Johnson, Blackburn (GB)

(73) Assignee: BAE SYSTEMS plc, London (GB)

(21) Appl. No.: 14/124,923

(22) PCT Filed: May 25, 2012
(86) PCT No.: PCT/GB2012/051180

§ 371 Date: Dec. 9, 2013

(30) Foreign Application Priority Data
Jun. 7, 2011 (GB) 1109535.3

(51) Int. Cl. H04L 12/26; H04L 29/08

(52) U.S. Cl. CPC H04L 43/18; H04L 67/02
USPC 709/217

(57) ABSTRACT

A method and system for assessing message interoperability between a first platform and a second platform communicating over a Tactical Data Link (TDL). The method includes obtaining first platform model data representing platform-specific message transmit/receive information over the TDL for the first platform and obtaining second platform model data representing platform-specific message transmit/receive information over the TDL for the second platform. The first platform model data and the second model platform model data are used to assess message interoperability between the first platform and the second platform.

The present invention relates to platforms communicating over a Tactical Data Link.

The domain of the Tactical Data Links (TDLs/TADIL) comprises a family of related technologies that have been developed over many years to coordinate and control the dissemination of information within the battlespace to support joint and combined operations. Consequently, various forms of TDL have been developed to support specific battle groups. The TDLs feature differing waveforms, bandwidths, protocols and capabilities. The US identifies members of the domain of TADILs via a postfix identifier (e.g. A, B, C, F, J, K, M). In addition to these, a number of TDLs are under development to support specific roles, such as the control of autonomous vehicles and intelligence video feeds.

The TDLs are generally defined by either, and in some cases both, of two families of standards: NATO STANAGs and US Department of Defense MIL-STDs. Although only partial coverage of the TDLs is provided, each standard provides a definition of one or more variant of TDL implementation. There also exist standards relating to the data forwarding from one TDL to another, e.g. STANAGs 5601 & 5616. It is important to note that these standards are document-based and, in some cases, very large indeed, in the case of MIL-STD-6016D extending to 8800 pages.

The exchange of information across the TDL at the brain-to-brain level is based on the common understanding of a clear semantics of the messages to be exchanged by cooperating assets. Unfortunately, the standards (STANAG 5516 & MIL-STD-6016C) describing the most widely used TDL, Link 16 (or TADIL-J), do not provide an adequate level of rigour and are not based on any discernable model. The standards are expressed primarily in narrative form and are voluminous; for instance, MIL-STD-6016D comprises in excess of 8800 pages. Furthermore, the standards describe the link requirements for all possible domains; in practice, most platforms will only implement a subset of the standard as is deemed appropriate to the platform's role (e.g. fighter, bomber, reconnaissance, etc.). However, the standards do not provide an explicit definition of common platform profiles.

This situation leads to variations in TDL implementations across similar platforms and the situation is exacerbated by the use of terminals produced by different vendors. The resulting situation makes an analysis of platform interoperability very labour intensive and potentially error prone. Furthermore, the interoperability analyses tend to occur towards the end of the life-cycle after the equipment has been specified and developed, making changes and/or corrections expensive in terms of both time and finances.

Assessing a TDL platform's compliance against the link standard (e.g. as described by MIL-STD-6016C) is therefore a challenging task. The TDL standards (such as 6016C) are known to suffer from a number of issues, such as: use of natural language; ambiguity; document size and structure, and consistency and completeness.

Embodiments of the present invention are intended to address at least some of the problems discussed above.

According to a first aspect of the present invention there is provided a method of assessing message interoperability between a first platform and a second platform communicating over a Tactical Data Link, the method including:

obtaining first platform model data representing platform-specific message transmit/receive information over the TDL for the first platform;

obtaining second platform model data representing platform-specific message transmit/receive information over the TDL for the second platform, and

using the first platform model data and the second platform model data to assess message interoperability between the first platform and the second platform.

The models may be used to check whether the second platform is capable of receiving at least one message type sent by the first platform in order to determine the interoperability.

The first platform model data can specify a set of message types and at least some of the message types can have an associated Data Field Identifier (DFI), an associated Data Use Identifier (DUI), and zero or more Data Items (DIs). The second platform model data can also specify a set of message types and at least some of the message types can have an associated Data Field Identifier (DFI), an associated Data Use Identifier (DUI), and zero or more Data Items (DIs). The models of both transmitting and receiving platforms can also accommodate aliasing of Data Item (DI) fields such that a platform may indicate that it receives a particular DI value but interprets this value as if some other value had been received. Furthermore, the models can also accommodate asymmetric transmit/receive characteristics of DIs such that a platform could apply different semantics to a specific DI value for transmit and receive purposes. The checking of whether the second platform is capable of receiving the message type sent by the first platform can include checking whether the associated DFI/DUI and the associated collection of DIs of a said message type have matching values and transmit/receive characteristics in the first and the second platform model data, e.g. to confirm that the first platform can transmit the DI value x within a given message and DFI/DUI and the second platform can receive the same DI value within the same message and DFI/DUI, and accommodating the possibility of an aliased value.

The method may include creating the first platform model data and the second platform model data using information derived from at least part of a standards document relating to the TDL. The creating may include parsing at least part of the standards document to produce at least one model template relating to the TDL standard. The model template may comprise an executable model, e.g. one or more files compatible with a relevant tool such as XMF or the Eclipse Modelling Framework (EMF). The method may include analysing an implementation document, such as an Actual Platform Implementation Specification (APIS), for the first and/or the second platform and using a suitable extension to the model template to create the model data for the first and/or the second platform.

The TDL standard document may comprise a Link 16 Standard document. Message information in the model template may be derived from at least part of a Data Dictionary portion of the standards document. The message information in the model template may be derived from at least part of a Message Catalogue portion of the standards document. The message transmit/receive information in the first and/or the second platform model data may be derived from a J-Message transmit/receive portion of the APIS. The message transmit/receive information may be used to associate DFI/DUI and DI data with a message type.

The method may include rendering results of the interoperability analysis in a variety of forms that may include (but not limited to) HTML.

According to another aspect of the present invention there is provided a method of generating at least one model for assessing message interoperability between platforms communicating over a TDL substantially as described herein.

According to other aspects of the present invention there are provided systems configured to execute methods substantially as described herein.

According to other aspects of the present invention there is provided a computer program element comprising: computer code means to make the computer execute methods substantially as described herein. The element may comprise a computer program product.

According to other aspects of the present invention there is provided a computer program element comprising: computer code means to make the computer execute methods substantially as described herein. The element may comprise a computer program product.

Whilst the invention has been described above, it extends to any inventive combination of features set out above or in the following description. Although illustrative embodiments of the invention are described in detail herein with reference to the accompanying drawings, it is to be understood that the invention is not limited to these precise embodiments. As such, many modifications and variations will be apparent to practitioners skilled in the art. Furthermore, it is contemplated that a particular feature described either individually or as part of an embodiment can be combined with other individually described features, or parts of other embodiments, even if the other features and embodiments make no mention of the particular feature. Thus, the invention extends to such specific combinations not already described.

The invention may be performed in various ways, and, by way of example only, embodiments thereof will now be described, reference being made to the accompanying drawings in which:

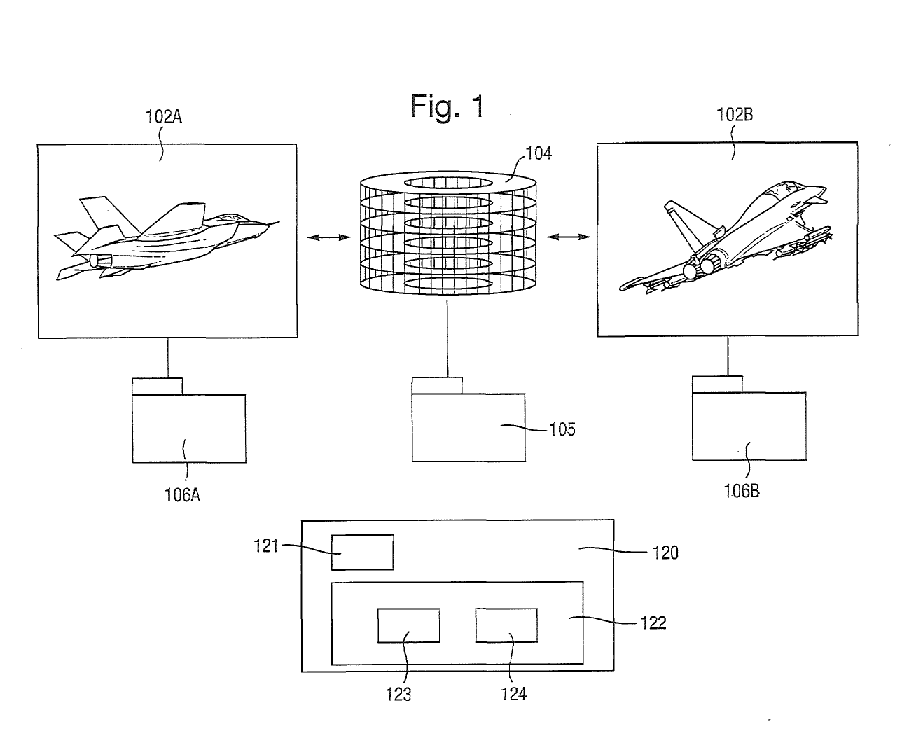

FIG. 1 schematically illustrates an example of message interoperability analysis for two platforms communicating over a TDL network, including a computing device configured to execute a tool for assessing message interoperability;

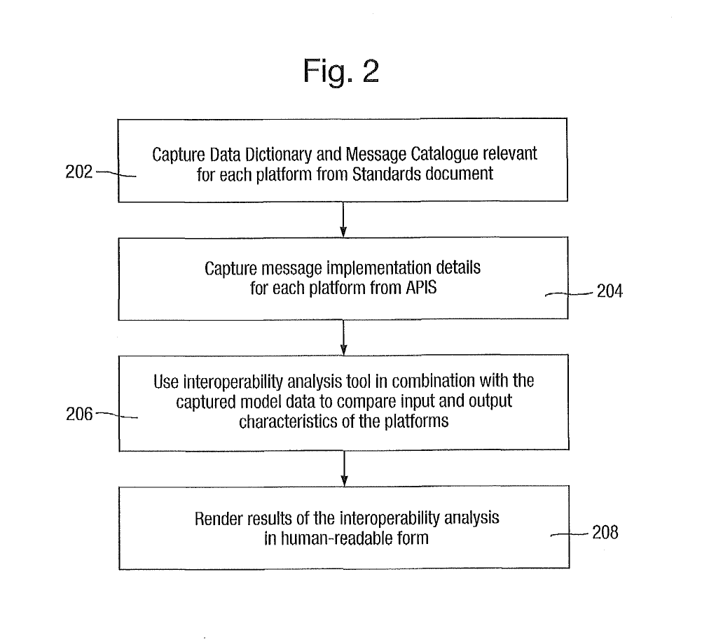

FIG. 2 illustrates steps performed in order to be able to assess message interoperability, including use of the tool;

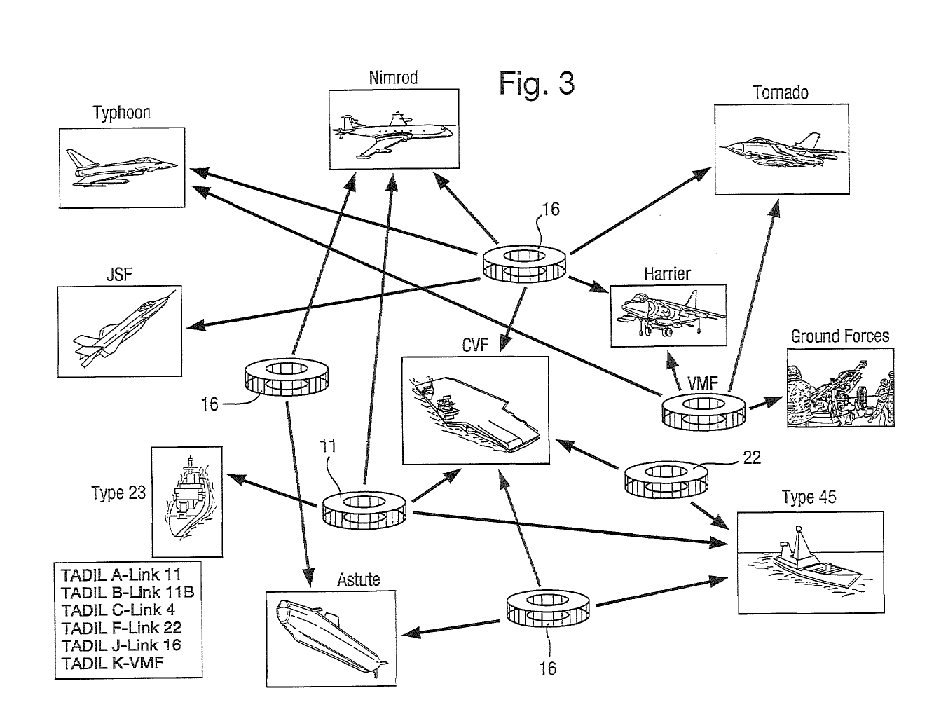

FIG. 3 illustrates an example of TDL linkage;

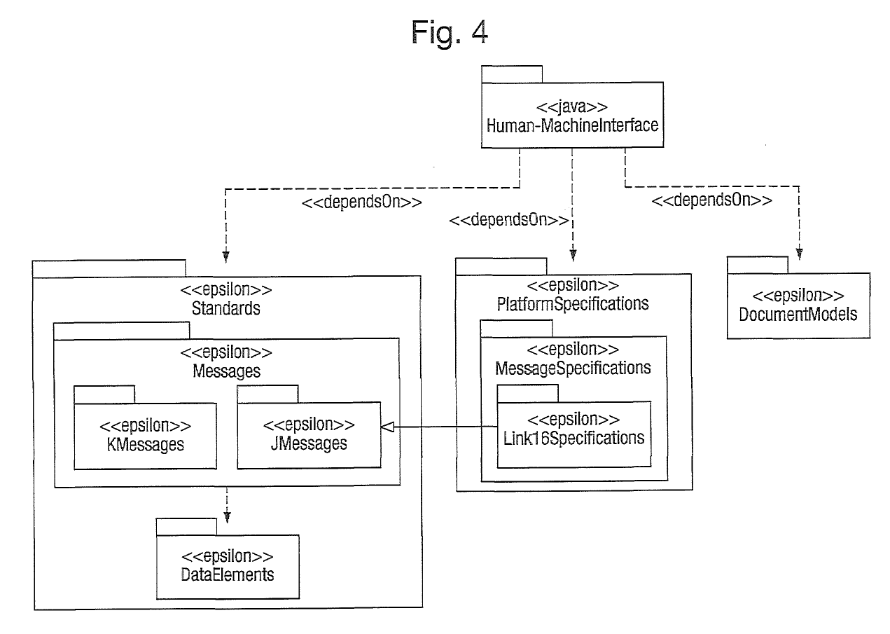

FIG. 4 illustrates a set of interrelated models that can be used by the tool;

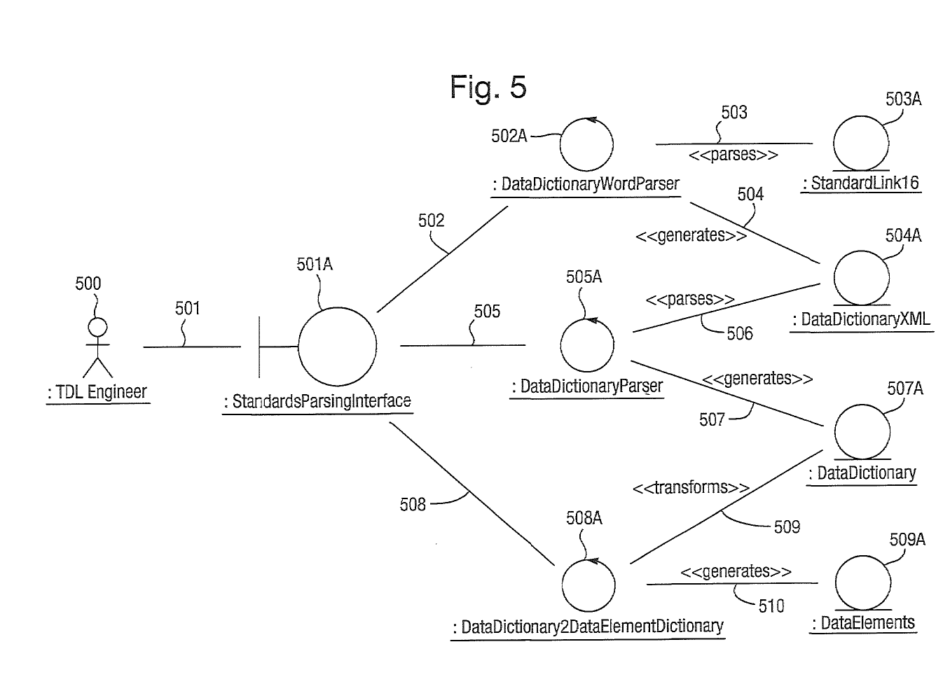

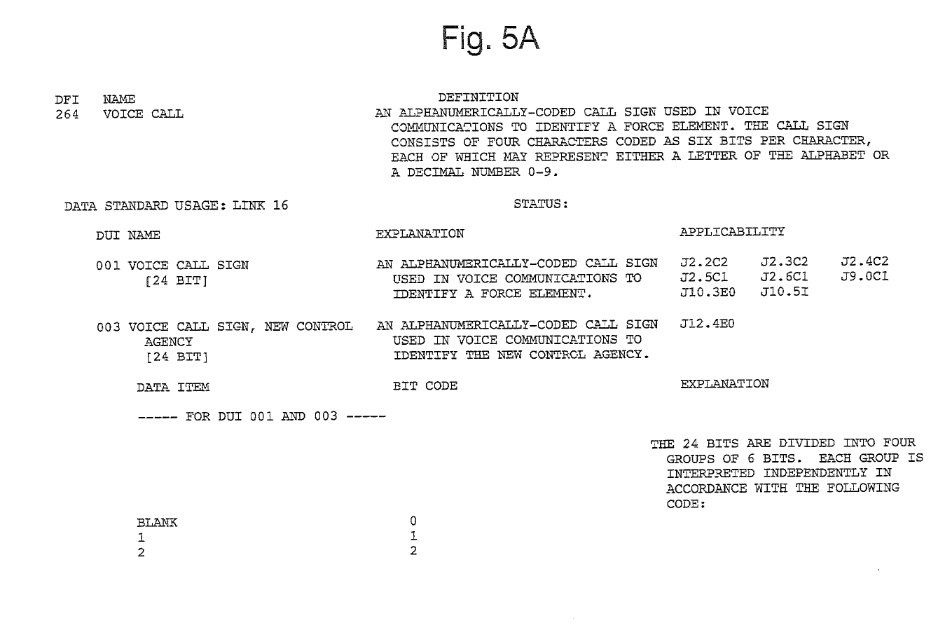

FIG. 5 is a collaboration diagram illustrating steps performed by embodiments of the method, including generating models;

FIG. 5A illustrates an example DFI/DUI definition;

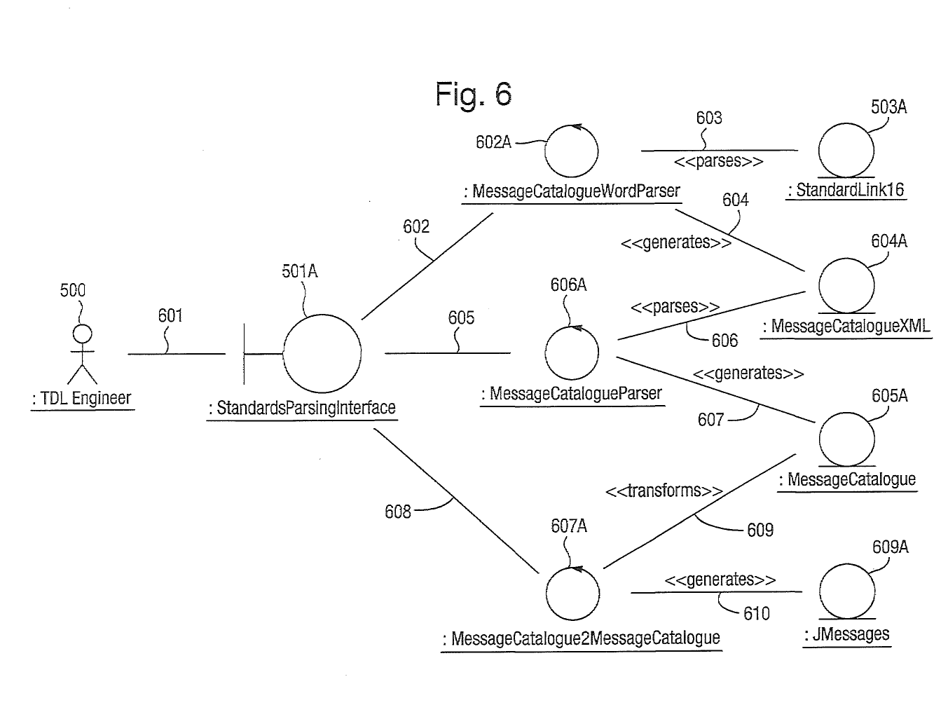

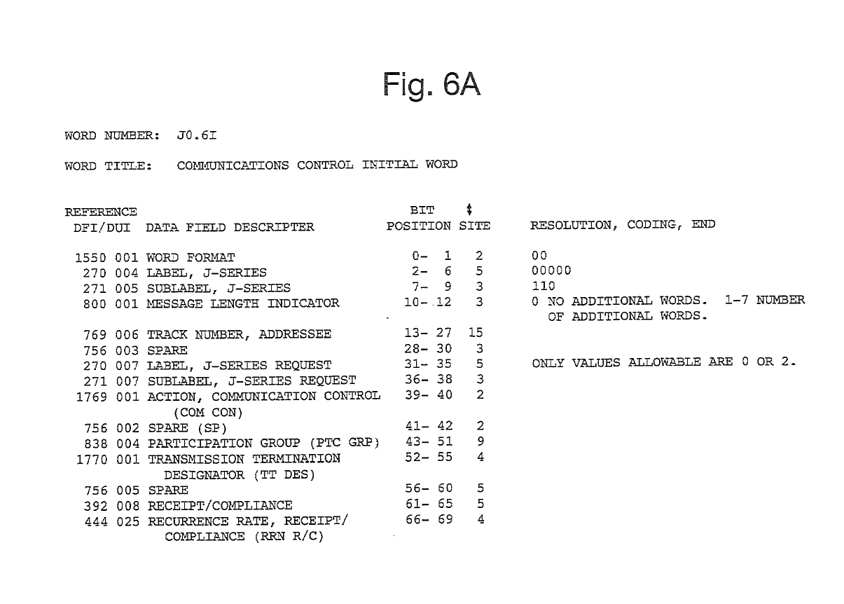

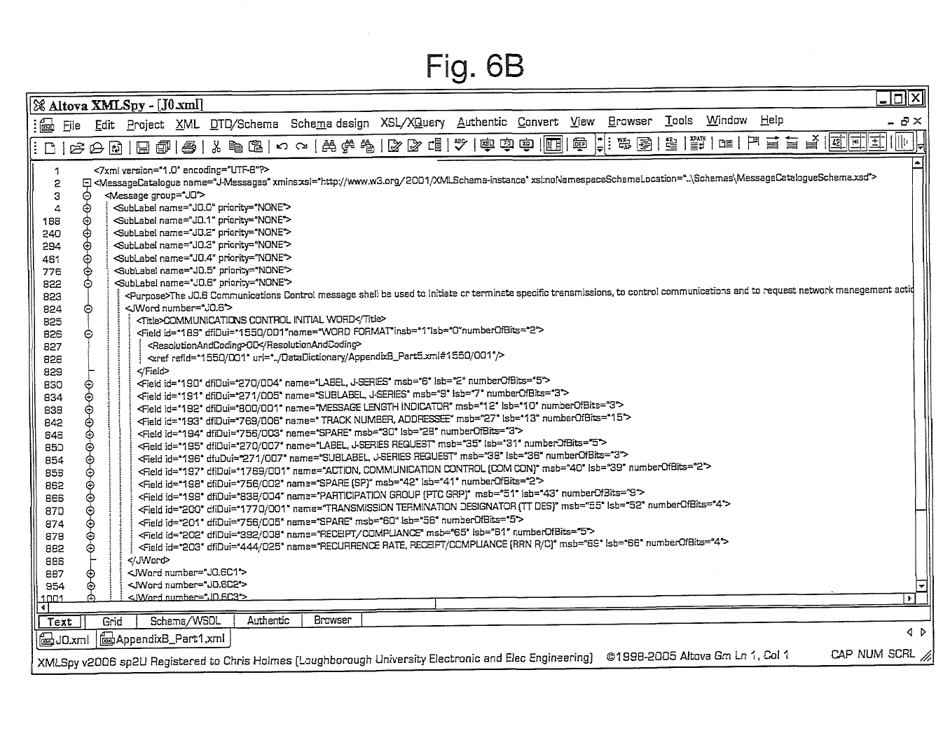

FIG. 6 is another collaboration diagram illustrating steps performed by embodiments of the method, including generating models;

FIG. 6A illustrates an example J-Word J0.6I definition;

FIG. 6B illustrates an XML representation resulting from parsing the definition of FIG. 6A;

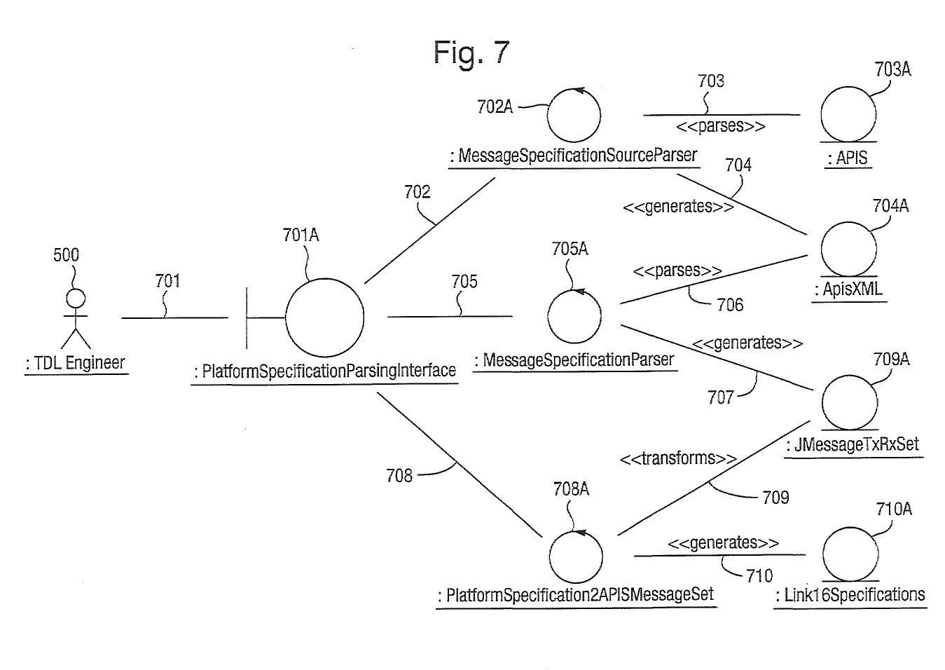

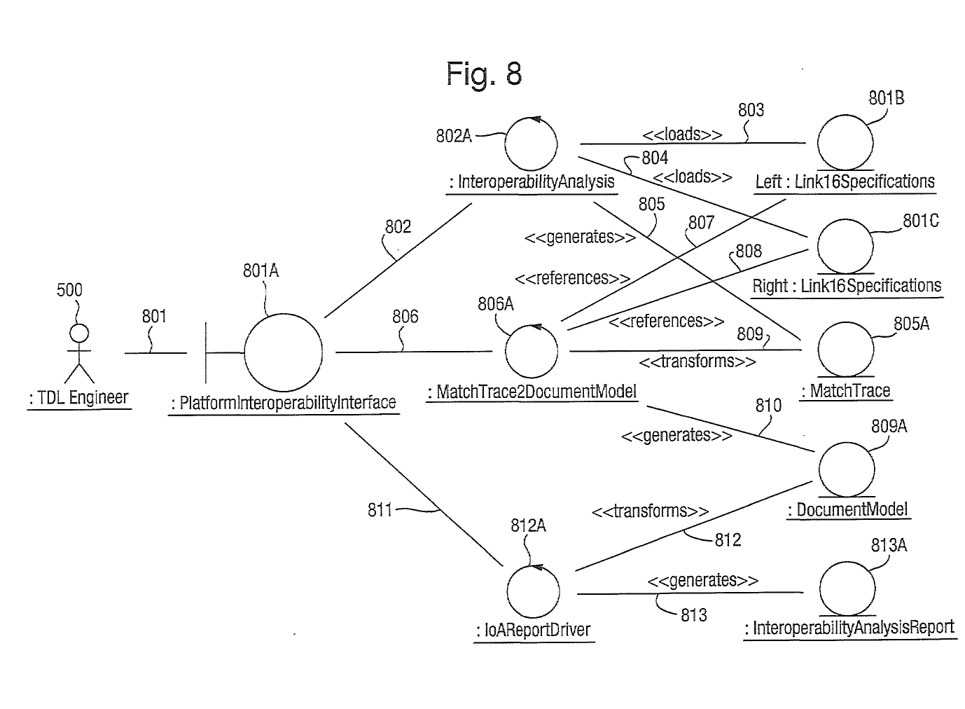

FIGS. 7-8 are collaboration diagrams illustrating steps performed by embodiments of the method, including generating models;

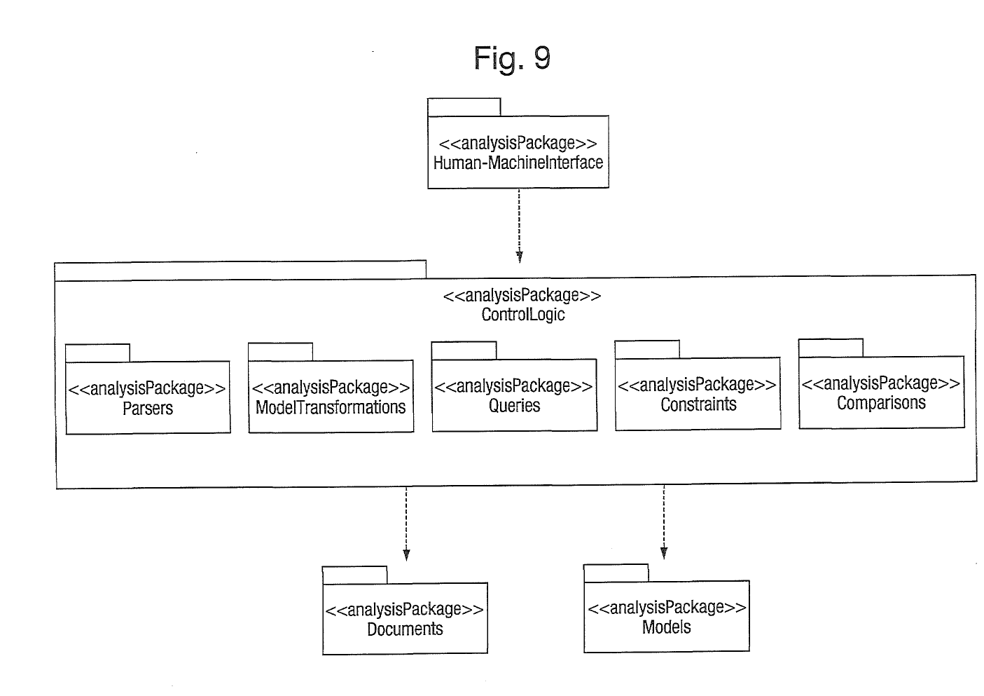

FIG. 9 is an abstract system architecture diagram;

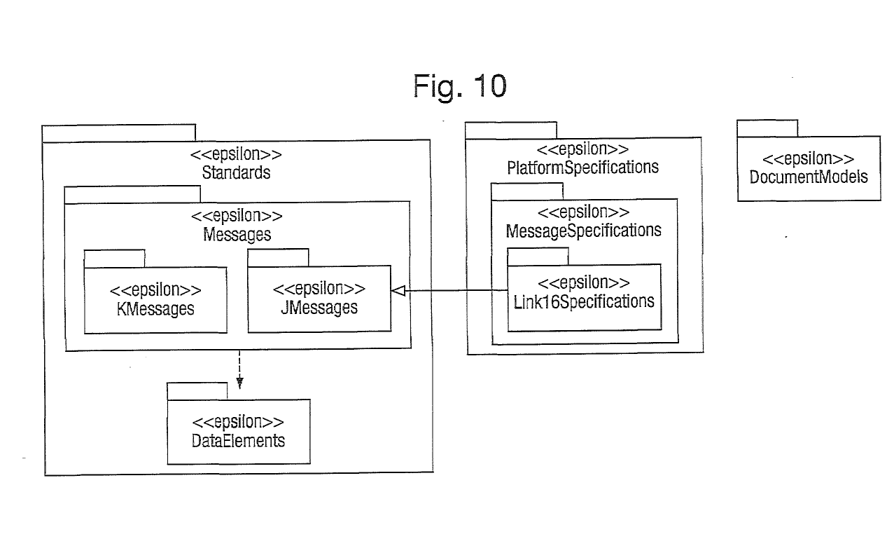

FIG. 10 illustrates a domain model;

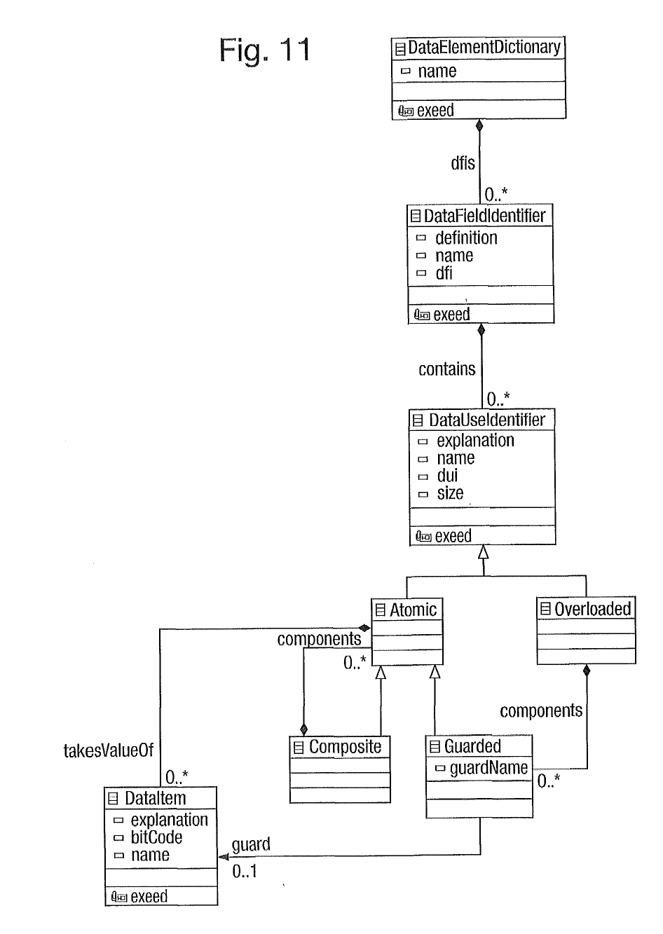

FIG. 11 illustrates a data elements model;

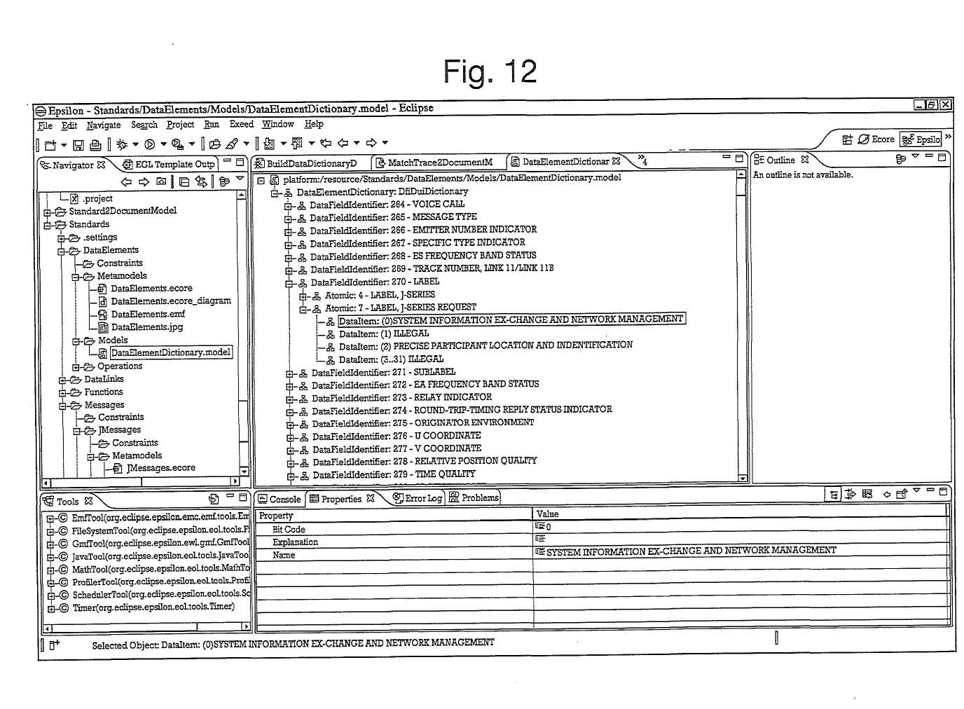

FIG. 12 is an example screen display relating to the data elements model;

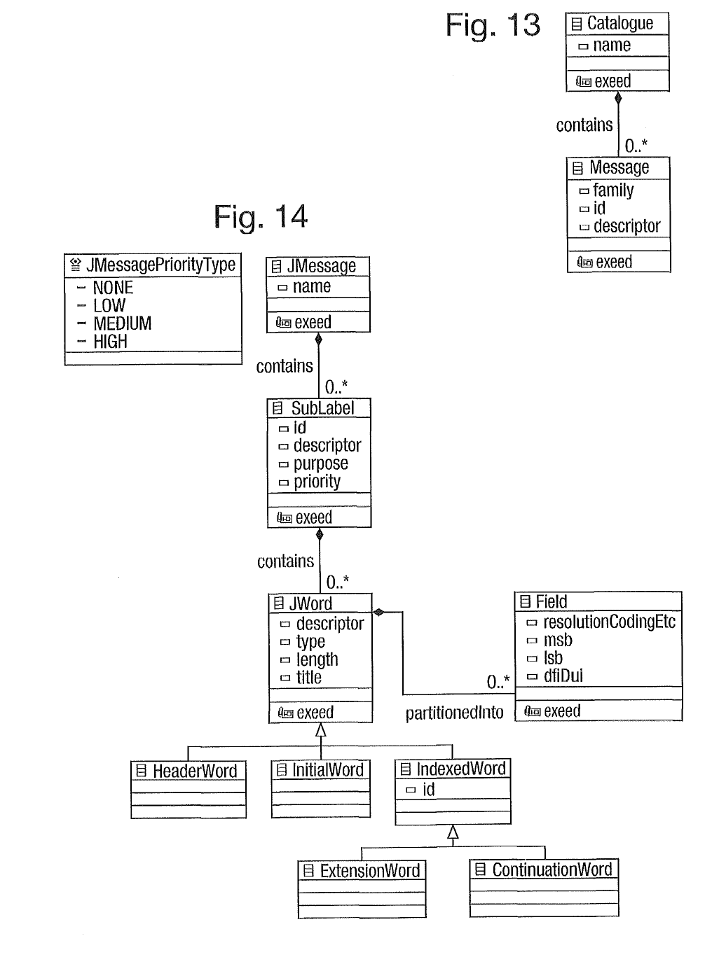

FIGS. 13 and 14 illustrate message and J-Messages models, respectively;

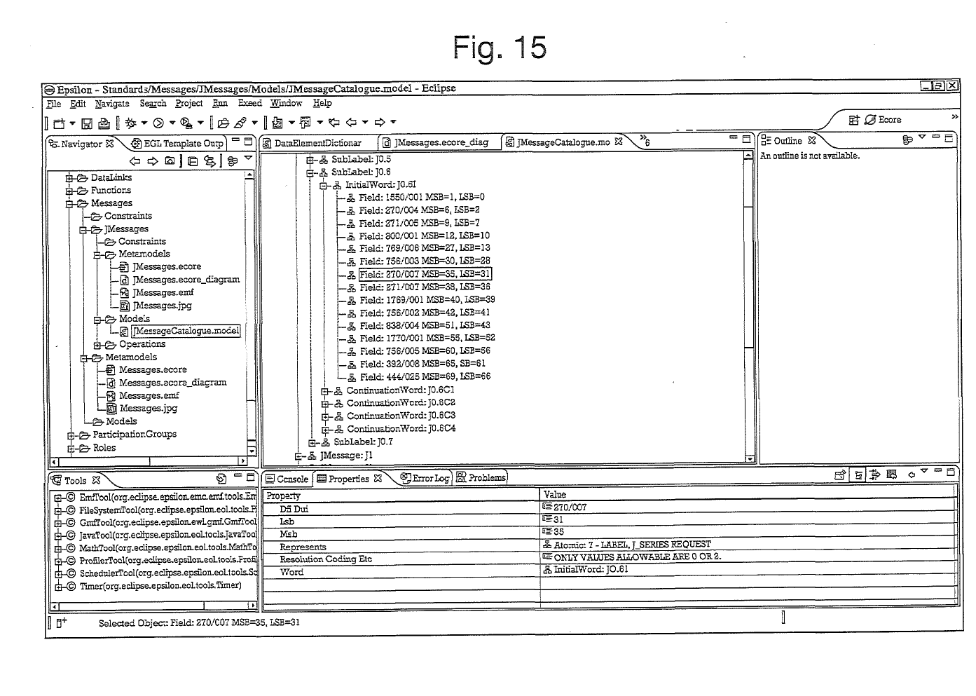

FIG. 15 is an example screen display relating to the J-Messages model;

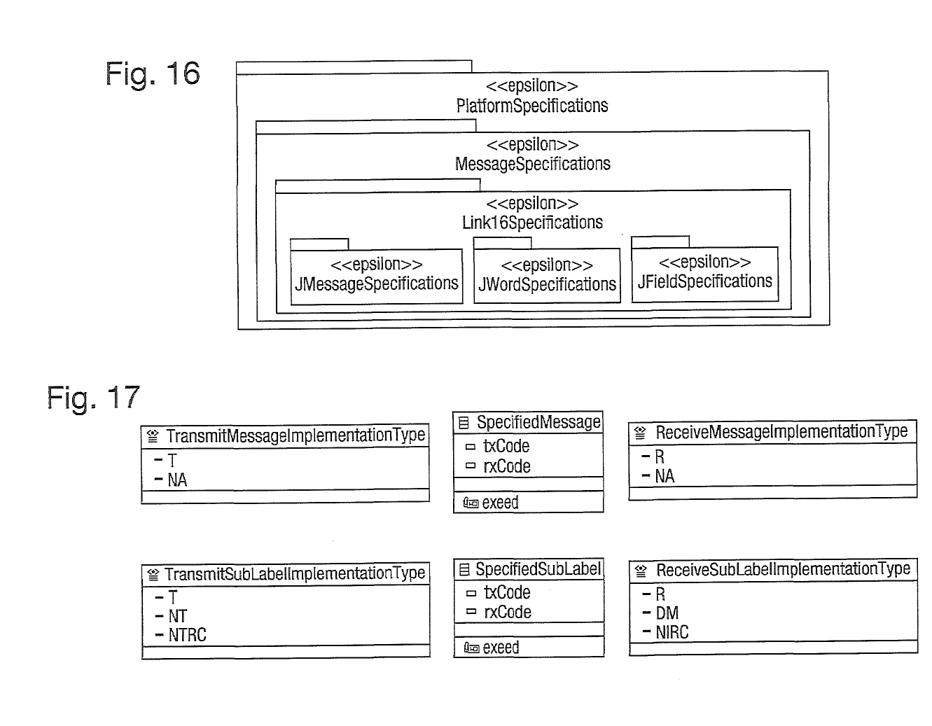

FIG. 16 illustrates a message specification package structure;

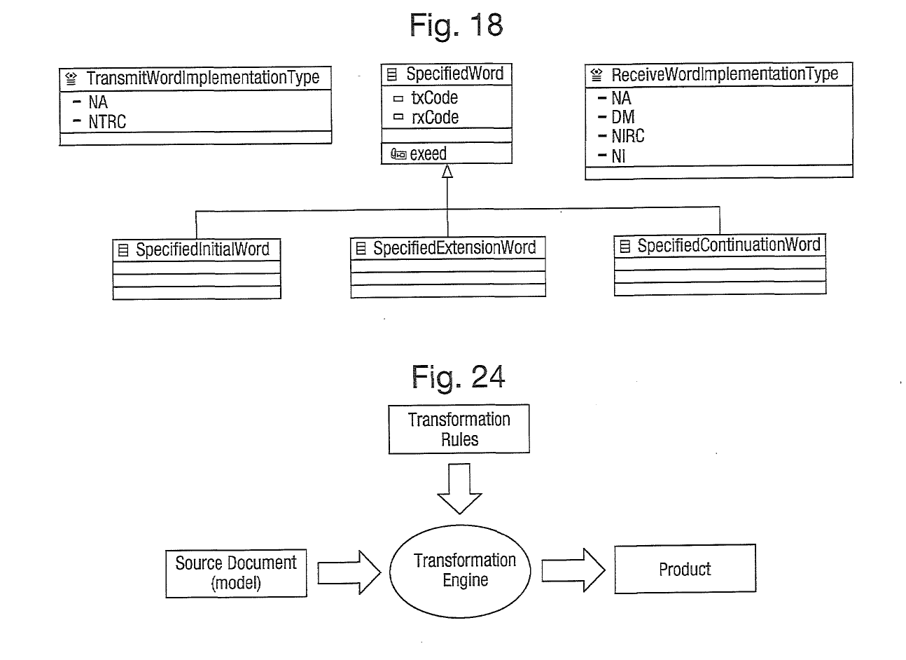

FIGS. 17 and 18 illustrate J-Message and J-Word, respectively, specifications models;

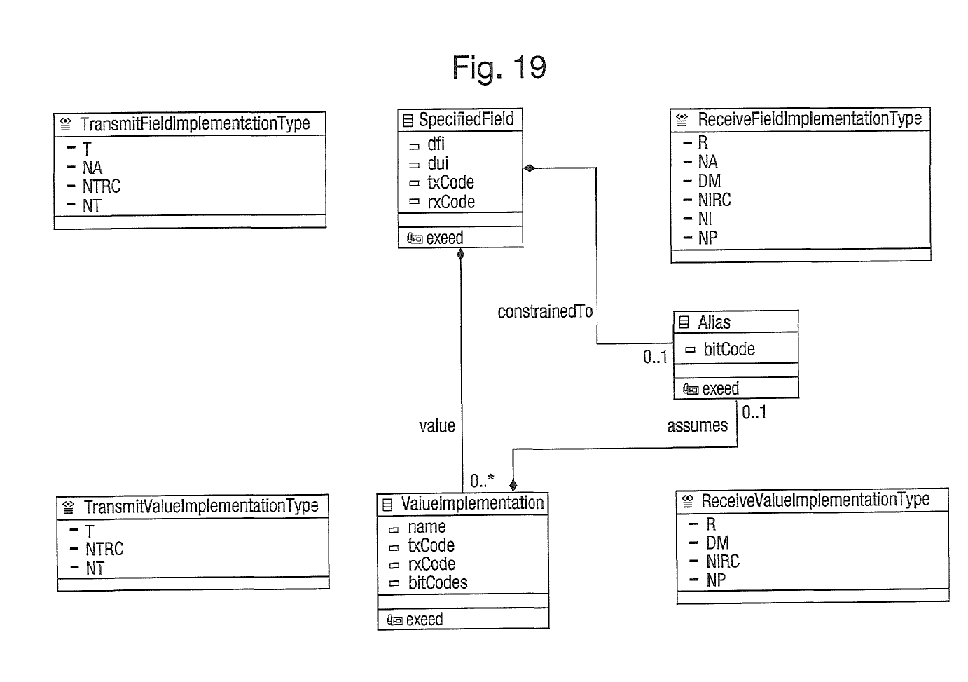

FIG. 19 illustrates a J-Field specifications model;

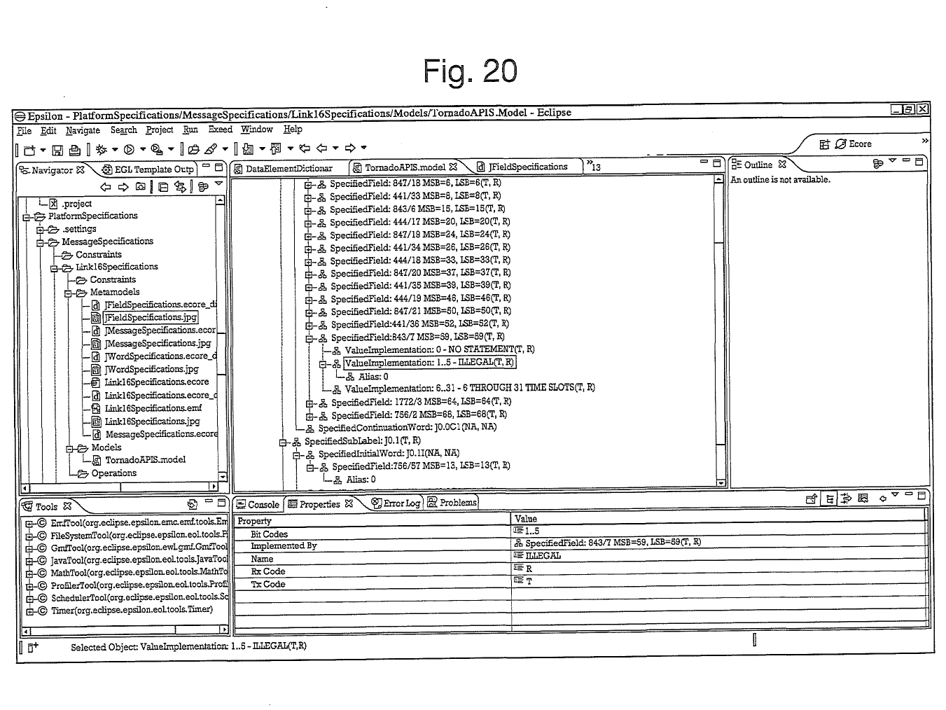

FIG. 20 is an example screen display relating to a platform specification model;

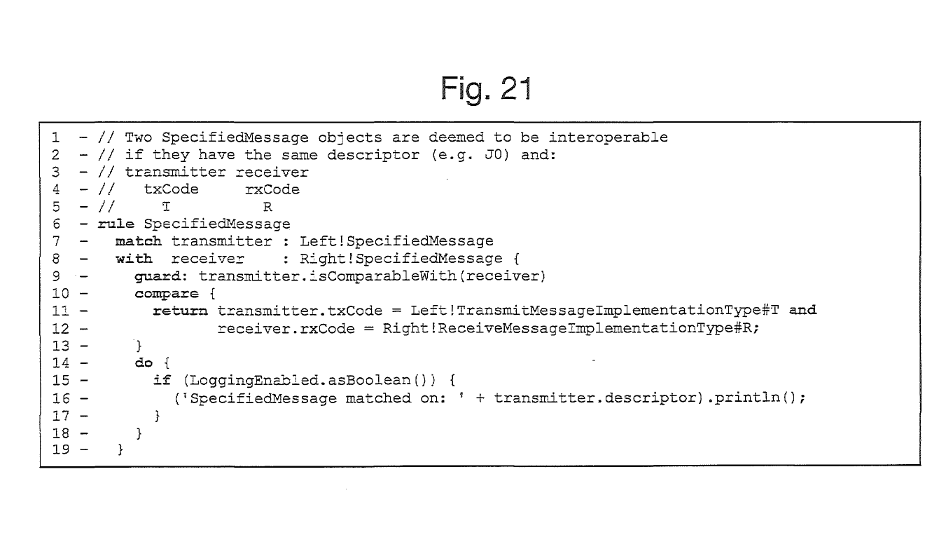

FIG. 21 shows example code relating to comparison of specified message instances;

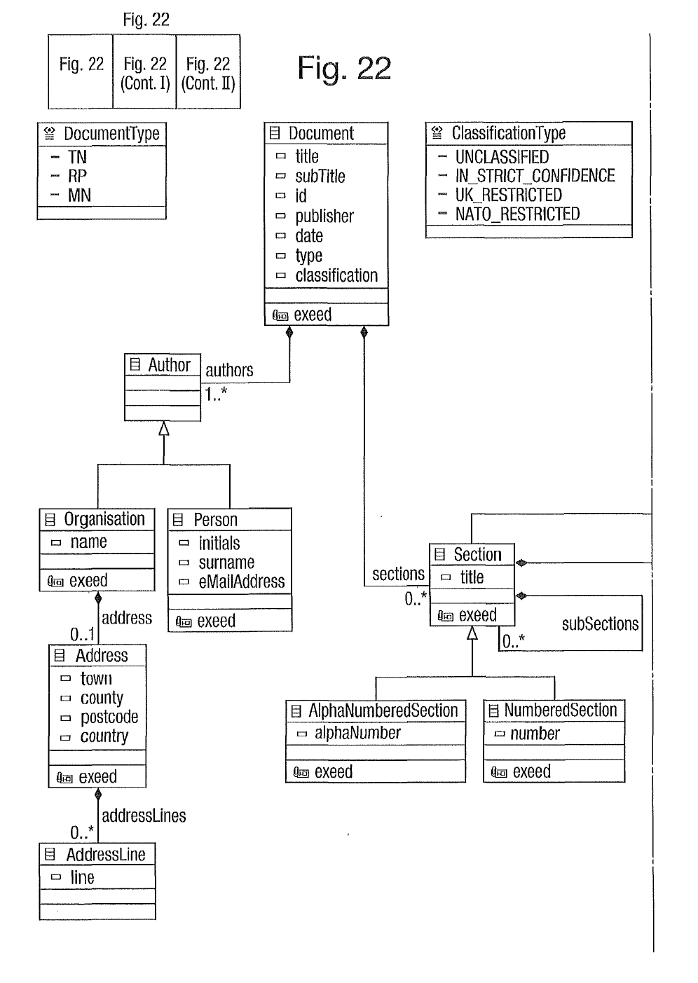

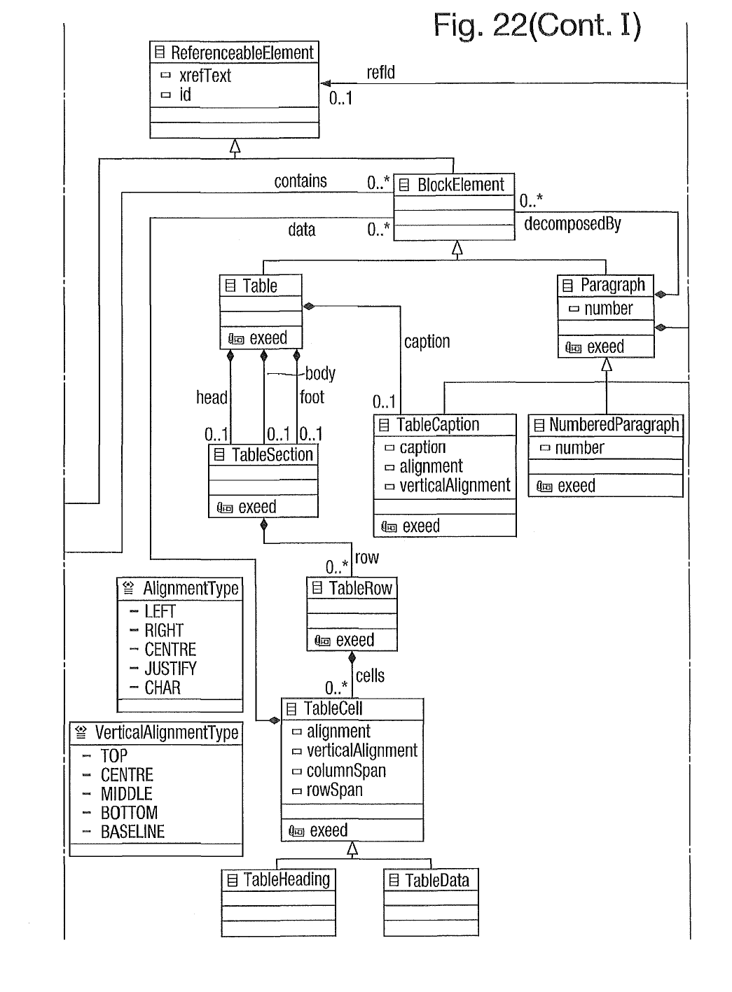

FIG. 22 illustrates a document model;

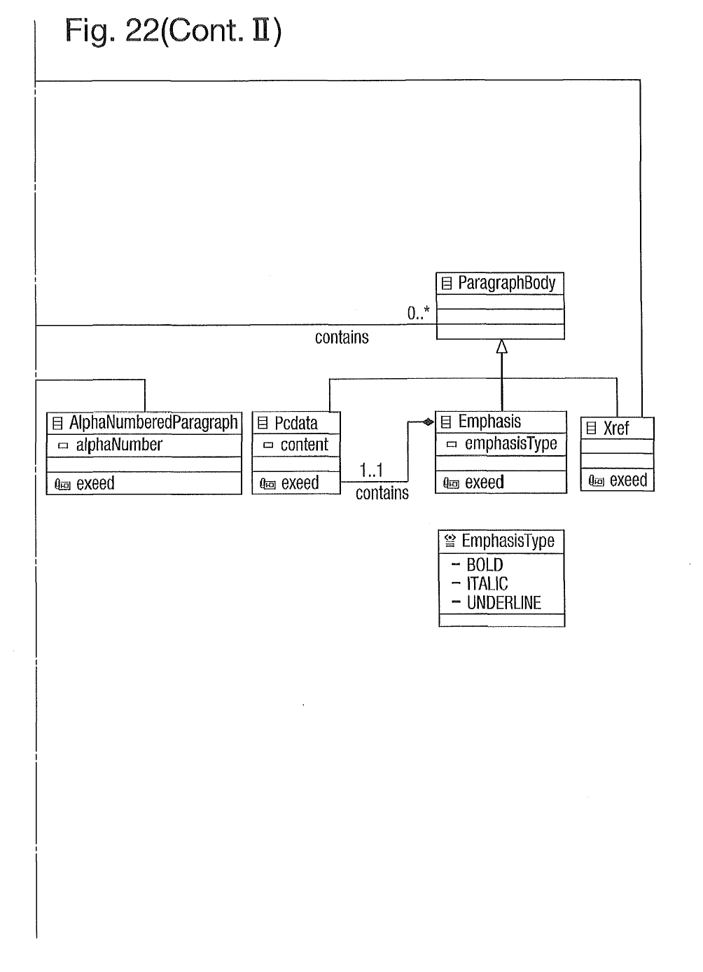

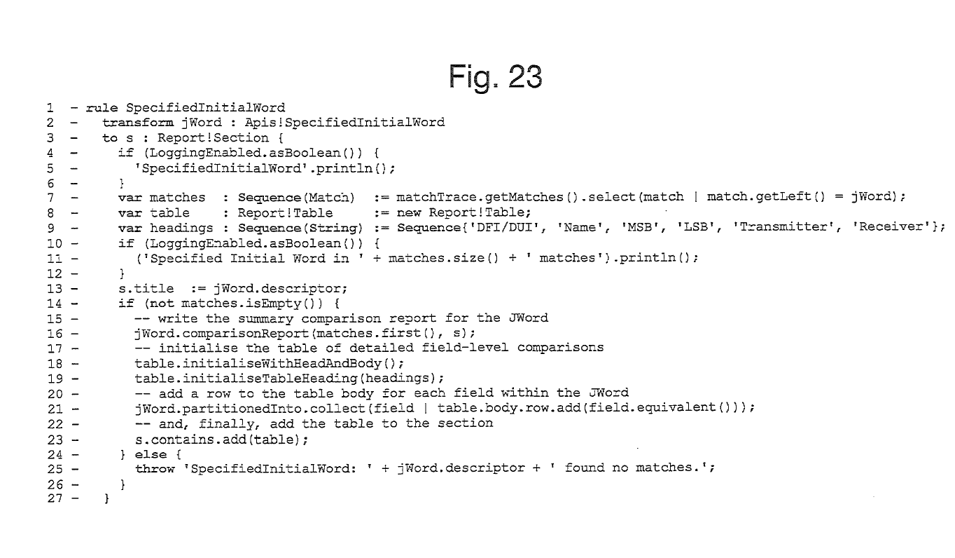

FIG. 23 shows example code relating to document model transformation;

FIG. 24 illustrates schematically document transformation, and

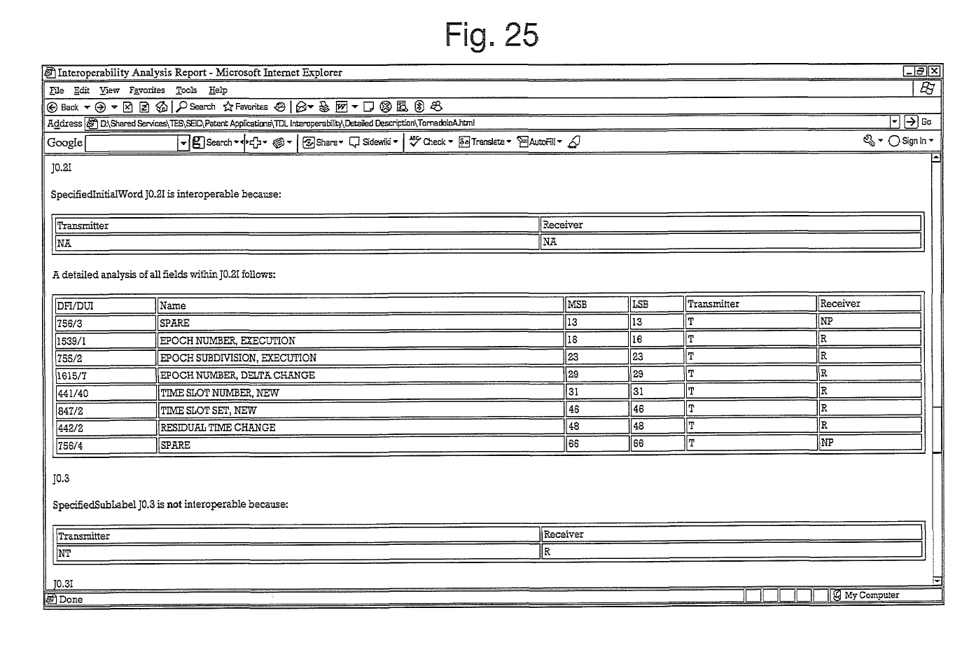

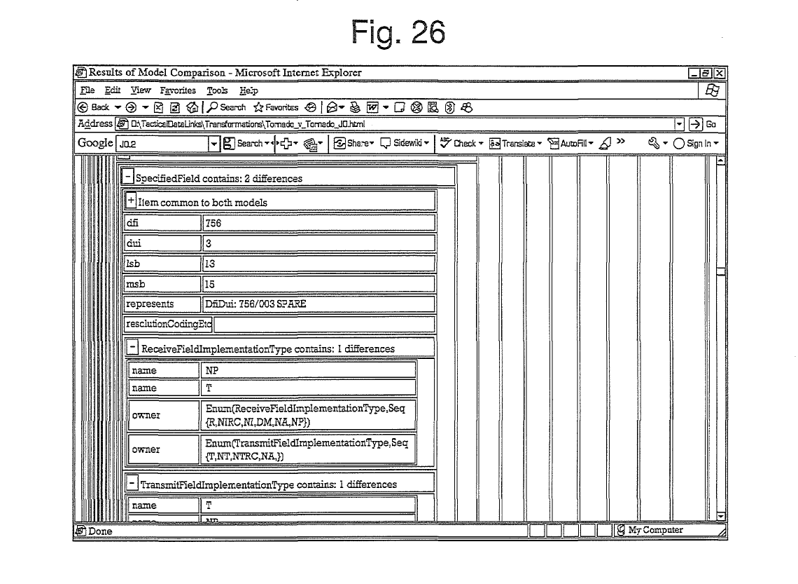

FIGS. 25 and 26 are example screen displays showing interoperability analysis reports.

FIG. 1 shows a first platform 102A and a second platform 102B. In the example the platforms comprise two different types of aircraft, although the term “platform” is intended to be interpreted broadly and can cover any type of vehicle, installation, etc, that needs to be put into communication with another platform of the same or different type. In the example the platforms communicate tactical data via a Link 16 TDL network 104, although it will be understood that embodiments of the present invention can be produced for dealing with any type of data being transferred over any type of TDL.

The Link 16 communication characteristics for each of the platforms 102A, 102B are defined by respective specifications, which in the example take the form of the underlying communication link standard(s)—the TDL base standard 105—and the elements of the base standard implemented by the platform 106A and 106B, which may comprise Actual Platform Implementation Specification (APIS).

FIG. 1 further schematically shows a computing device 120 including a processor 121 and a memory 122 storing a tool 123 for executing a method of assessing message interoperability. The computing device may be located onboard either or both of the platforms 102A, 102B, or at a remote location. Data based on the base standard and the implementation 106A, 106B is processed to produce a model 124 that represents communication characteristics of the platforms. The model can be used by the tool 123 for running queries that assist with assessing message interoperability between the platforms.

FIG. 2 illustrates steps that can be performed in order to be able to assess message interoperability over a TDL link. A description of the system can be created and this can be illustrated by a number of collaboration diagrams showing the types of communicating analysis objects required using three standard stereotypes: boundary, control, and entity. Four main tasks are required. In the first of these, labelled step 202, the TDL Engineer captures the Data Dictionary and Message Catalogue relevant to each platform in question (in the example described in detail herein the discussion is restricted to the Data Dictionary and Message Catalogue defined for Link 16 (see US Department of Defence, ‘Tactical Data Link (TDL) 16 Message Standard’, MIL-STD-6016C, 31 Mar. 2004), although it should be noted that there are both other families of data link (as illustrated in FIG. 3) and also other standardisation documents, e.g. STANAGs, for which the method can be adapted).

At step 204 the TDL Engineer captures the message implementation details for each platform in question from the relevant document (typically, this is provided by the APIS). The data captured at steps 202 and 204 are used to produce model data 124 and at step 206 the TDL Engineer uses the interoperability analysis tool 123 in combination with the model data to compare the field-level input and output characteristics of the platforms (which may comprise two instances of the same platform if “own-ship” interoperability is to be assessed—one would do this if one wished to confirm message-level interoperability between two platforms of the same type). At step 208, the TDL Engineer renders the results of the interoperability analysis in some human-readable form, e.g. HTML. The model-based approach adopted by the embodiments provides flexibility in output formats, hence MS Word™, MS Excel™, etc. can be supported with ease.

As a result of an analysis of the information contained in the source material documenting the message set in both the TDL standard (the “base standard”) and the platform implementation (the APIS), and the desire to separate semantic from presentation aspects the present inventors have designed a set of interrelated models in the UML packages Standards, PlatformSpecifications, and DocumentModels (see FIG. 4). Whilst a number of different data link technologies are deployed in the battlespace, the embodiment detailed herein relates to the Link 16 message family (J-messages), although other message families exist, e.g. VMF uses the K-message family, Link 11 uses the M-message family, etc, and the embodiments could be adapted to assess interoperability of platforms using these.

The source material comprises a document-centric approach to the definition of both the TDL standard and the implementation provided by individual platforms. This information is voluminous (e.g. a current Link 16 standard is in excess of 8800 pages) and difficult to verify as correct. Embodiments described herein use document parsers to capture the document-based information in the form of populated models and the approach taken is to parse the source material via a number of hand-written parsers and generate a number of XML documents conforming to defined schemata. The use of an associated XML schema provides both well-formedness and validity checking of the XML documents. These XML documents are then parsed into a modelling tool to instantiate the relevant models and perform the interoperability analysis and rendering of results. Specific embodiments use both XMF (Mosaic) and the Eclipse Modelling Framework (EMF; see, for example, Stienberg, D., Budinsky, F., Paternostro, M., Merks, E., ‘EMF—Eclipse Modeling Framework’, 2^{nd} ed., Addison-Wesley, 2008), hence the interoperability analysis approach is not dependent upon any particular implementation technology. It should be noted that an additional benefit of a model-based approach, (re)capturing the source material in the form of an executable model is that well-formedness constraints may be applied to the resulting instantiation. Link-specific constraints may be provided to ensure well-formedness of the instantiated models, e.g. Link 16 requires that each J-Message contains exactly one Initial Word.

The population of the Standards and PlatformSpecifications models is illustrated in the UML-type collaboration diagrams of FIGS. 5-8.

Referring to FIG. 5, the TDL Engineer 500 creates 501 the Data Elements Model components via a Link 16 Standard parsing user interface 501A. For example, the DFI/DUI definition of FIG. 5A is parsed into the XML representation below:

```
<DataDictionary source=“DfiDuiDictionary”
  xmlns:xsi=http://www.w3.org/2001/XMLSchema-instance
  xsi:noNamespaceSchemaLocation=“../Schemas/
  DataDictionarySchema.xsd”>
      <DFI number=“264”>
            <Name>VOICE CALL</Name>
            <Definition>
AN ALPHANUMERICALLY-CODED CALL SIGN USED IN VOICE
COMMUNICATIONS TO IDENTIFY A FORCE ELEMENT. THE
CALL SIGN CONSISTS OF FOUR CHARACTERS CODED AS
SIX BITS PER CHARACTER, EACH OF WHICH MAY
REPRESENT EITHER A LETTER OF THE ALPHABET
OR A DECIMAL NUMBER 0-9.
            </Definition>
            <DUI id=“264/001” number=“001” subDUI=“”
            refPoint=“”>
                  <Size>24 BIT</Size>
                  <Name>VOICE CALL SIGN</Name>
                  <Explanation>
AN ALPHANUMERICALLY-CODED CALL SIGN USED IN VOICE
COMMUNICATIONS TO IDENTIFY A FORCE ELEMENT.
                  </Explanation>
                  <DI bitCode=“0”>
                        <Name>BLANK</Name>
                        <Explanation/>
                  </DI>
                  Etc.
            </DUI>
      </DFI>
</DataDictionary>
```

This allows the user to identify the relevant source data set to be used. A Data Dictionary Word Parser 502A parses 503 the component of the Link 16 TDL Standard 503A containing the Data Dictionary definition (this is in Appendix B of the standard referenced above) from the relevant MS Word document containing the part of the standard and generates 504 an equivalent document in XML 504A (a set of XML documents can be generated).

The XML document component of the Link 16 TDL Standard 504A is then parsed 506 and a model of the XML document 504A containing the relevant items of the Data Dictionary is generated 507. A Data Dictionary Parser 505A (an auto-generated component within the EMF see, for example, Stienberg, D., Budinsky, F., Paternostro, M., Merks, E., ‘EMF—Eclipse Modeling Framework’, 2^{nd} ed., Addison-Wesley, 2008) parses each Data Dictionary XML document 504A against the relevant XML document schema and populates the Data Dictionary Ecore model 507A. The Data Dictionary Parser 505A parses 506 the specified Data Dictionary XML document 504A. The Data Dictionary Parser generates 507 an Ecore model for the specified XML source document. The Data Dictionary to Data Element model transformation 508A transforms 509 and merges each Data Dictionary Ecore model 507A into a single Data Elements Ecore model 509A. The Data Dictionary model is transformed into a Data Elements model and a single Data Elements Ecore model 510A is generated 510 (see FIG. 12 for an example).

FIG. 6 is a collaboration diagram illustrating creation of a J-Messages model. The TDL Engineer 500 creates 501, 502 the J-Message Model components via the Link 16 Standard parsing user interface 501. This allows the user to identify the relevant source data set to be used. A Message Catalogue Word Parser 602A parses 603 the component of the Link 16 TDL Standard 503A containing the Message Catalogue definition (this is in Section 5, Parts 1 to 3 of the standard document referenced above) from the relevant MS Word™ document and generates 604 an equivalent document in XML (a set of XML documents are generated). For example, the J-Word J0.6I definition of FIG. 6A is parsed into the XML representation of FIG. 6B:

The MS Word document component of the Link 16 TDL Standard is parsed and an XML document 604A containing the relevant items of the Message Catalogue is generated. A Message Catalogue Parser 606A (an auto-generated component within the EMF see, for example, Stienberg, D., Budinsky, F., Paternostro, M., Merks, E., ‘EMF—Eclipse Modeling Framework’, 2^{nd} ed., Addison-Wesley, 2008) parses each Message Catalogue XML document 604A against the relevant XML document schema and populates the Message Catalogue Ecore model 606A. The Message Catalogue Parser 606A parses the specified Message Catalogue XML document 604A. The Message Catalogue Parser generates 607 an Ecore model 605A for the specified XML source document. The Message Catalogue to Message Catalogue model transformation 607A transforms 609 and merges each Message Catalogue Ecore model into a single J-Message Ecore model and binds each message field to the relevant Data Element (DFI/DUI) definition. The Message Catalogue model is transformed into a J-Message model 609A. A single J-Message Ecore model is generated 610 (see FIG. 15) and bound to the supporting Data Elements model 510A.

FIG. 7 is a collaboration diagram illustrating creation of a Link 16 platform specification model. The TDL Engineer 500 creates 701, 702 the Link 16 Specifications Model components via a Platform Specification parsing user interface 701A. This allows the user to identify the relevant source data set to be used. In some cases a Message Specification Source Parser 702A may parses 703 the component of the platform specification 703A containing the Message Catalogue transmit and receive characteristics (this is generally provided in a project-specific format and a bespoke parser is required for each format, MS Word™, Excel™, and DOORS are commonly used) and a set of XML documents are generated. The Message Catalogue component of the APIS is parsed 703. An XML document 704A containing the relevant items of the APIS Message Catalogue is generated 704. A Message Specification Parser 705A (an auto-generated component within the EMF) parses each APIS Message Catalogue XML document 704a against the relevant XML document schema and populates 707 the J-Message Tx/Rx Set Ecore model 707A. The Message Specification Parser parses the specified Message Catalogue XML document. The Message Specification Parser generates an Ecore model for the specified XML source document. The Platform Specification to APIS Message Set model transformation 708A transforms and merges each J-Message Tx/Rx Set Ecore model into a single Link 16 Specifications Ecore model 709a (see FIG. 20) and binds each message field to the relevant Data Element (DFI/DUI) definition. The J-Message Tx/Rx Set model is transformed 709 into a Link 16 Specifications model. A single Link 16 Specifications 710A Ecore model is generated 710 and bound to the supporting Data Elements model. Any housekeeping fields omitted from the APIS are copied from the base standard and have default transmit/receive characteristics applied (this is performed because some projects suppress such fields as they perceive their use as implicit).

FIG. 8 is a collaboration diagram illustrating creation of a message interoperability report. The TDL Engineer 500 creates 801 the Interoperability Analysis Report document via the Platform Interoperability user interface 801A. This allows the user to identify the relevant platforms to be compared (it is possible to either compare a Left platform against a Right platform, or compare a platform against itself (own-ship interoperability)). The Interoperability Analysis loads 803, 804 the Link 16 Specification models 801B, 801C for each of the platforms to be compared. The Interoperability Analysis comparison component 802A has a user-definable definition of what constitutes interoperability at the field (DFI/DUI) and DI level. The component generates 805 a Match Trace component 805A capturing the results of the comparison of the transmit characteristics of the Left model against the receive characteristics of the Right model. The Left Link 16 Specification model is loaded 803 and the Right Link 16 Specification model is loaded 804. A Match Trace object 805A is generated 805 containing the result of the Tx/Rx comparison of each field defined in the Left and Right models. The Match Trace to Document Model component 806A transforms 809 the Match Trace object into an instance of the Document Model 809A, the Match Trace to Document Model transformation makes reference to the source Left and Right Link 16 Specification Models in order to capture the necessary details of each Tx/Rx comparison result. The model transformation references the Left model to extract the necessary transmit characteristics of the platform. The model transformation references the Right model to extract the necessary receive characteristics of the platform. The Left model (transmitting platform) is traversed and the results of the comparison in the Match Trace transformed into the relevant components of the Document Model. An instance of the Document Model is generated 810 (this relates to the generic structure of a document, sections, subsections, tables, etc. rather than a rendering in a particular technology). An IoA Report Driver 812A traverses the Document Model instance and transforms 812 it into an HTML report of the results of the interoperability analysis (i.e. the Document Model is rendered in a particular technology, other technologies such as MS Word™, Excel™ could be supported). The Document Model is traversed and transformed 813 into a rendered instance of an interoperability analysis report 813A. The Interoperability Analysis Report is rendered (e.g. in HTML).

Having identified the relevant analysis classes (stereotyped as boundary, control and entity), it is possible to define an abstract system architecture and place each of the analysis classes in an analysis subsystem; a simple three-layer architecture can be adopted in this case (see FIG. 9).

The ability to perform interoperability analysis via an automated tool is facilitated by the detailed modelling of the necessary domain concepts and this can be achieved via an analysis of the source documentation, i.e. the base standard document referenced above and the project-specific APIS material, which is often provided via different tools (DOORS, MS Word™, MS Excel™ etc.) and in differing formats. The various formats, whilst different, relate to a common underpinning (and implicit) model. Relevant domain models are illustrated in FIG. 10.

Each data element in the Data Elements Model is defined by the standard in the form of a DFI/DUI (Data Field Identifier/Data Use Identifier). The DFI provides the concept of a data type family (e.g. Label), whilst the DUI proves a refinement of this concept (e.g. Label, J-Series Request), both the DFI and DUI are identified by numeric codes, e.g. Voice Call sign is identified by the DFI/DUI 270/007. Furthermore, the standard defines the size of each DFI/DUI, the resolution and/or enumerated values are also defined via the notion of Data Items (DIs). There is some additional complexity applied to certain DFI/DUIs via the notion of overloading, such that the same DFI/DUI may relate to different definitions depending upon the context (which is provided by the value of another DFI/DUI, and the composition of some DFI/DUIs from a collection of definitions (where the same DI definitions are shared by multiple DFI/DUIs). Finally, the collection of Data Element objects is contained in a dictionary. The DataElements domain model captures the above semantics (see FIG. 11).

The parsers and transformations discussed above allow the Data Elements model to be populated with data extracted directly from the Link 16 Standard reference above. FIG. 12 shows a screenshot of the resulting model instance browsing DFI/DUI 270/007.

J-Messages in the J-Messages Model are exchanged between cooperating Link 16 platforms. The messages are arranged in functionally-oriented groups. J-Messages comprise a varying number of J-Words of fixed size (70 bits). J-Words are of various types (Initial, Extension, Continuation), and each J-Word comprises a number of fields, each of which is drawn from the underlying dictionary of Data Elements (which defines the relevant characteristics such as the size in bits). Some of the modelling concepts described herein will be common to other forms of TDL, hence a root package Messages has been defined to contain all common concepts. In some embodiments this contains only the class Catalogue (the class responsible for holding the collection of messages), and the abstract class Message that is to be specialised for each type of TDL message (see FIG. 13).

The Message concept is specialised by the class JMessage in the package JMessages to represent the root of the domain of J-Messages. Each J-Message (e.g. J0) is defined by a number of functionally-oriented sub-labels (e.g. J0.0, J0.1, etc.), each of which contains a number of J-Words. The concept of a J-Word can be represented via the abstract class JWord and this can be specialised to represent each of the concrete J-Word types. Each J-Word is partitioned into a number of fields defining the link to the relevant DFI/DUI and the location in the 70 bit J-Word at which the DFI/DUI is to be located; hence the class Field provides linkage to the underlying Data Elements model. The structure of the J-Message model is shown in FIG. 14. The parser and transformation described above allow the J-Messages model to be populated with data extracted directly from the Link 16 Standard document referenced above. FIG. 15 shows a screenshot of the resulting model instance browsing a field of type DFI/DUI 270/007 within the Initial Word J0.6I.

The capture of the Data Elements and Message Catalogue for the Link 16 from the base standard has been described above. The base standard and, hence, the populated models, define the fully enumerated space of messages and data types permitted. In practice, however, a platform is likely to be required to implement only a subset of the base standard; furthermore, each platform must make some statement on the implementation provided—this is described in a platform-specific implementation specification, often referred to as the APIS. The section of the APIS relating to the message catalogue defines the messages, words and fields that are to be implemented and also defines the transmit/receive characteristics. For instance: field x may be transmitted; field x will not be transmitted; field x may be received; field x will not be received; the receipt of field x with a value y will be interpreted as if it had been received with a value z

The Tx/Rx characteristics are declared hierarchically in relation to the Field, from the message Sub-Label to the J-Word, to the Field. This represents an extension to the domain model described below.

The Platform Specifications model can be structured in the form of a number of nested packages as illustrated in FIG. 16. The package structure reflects the anticipation of a future requirement to support other aspects of a platform specification (APIS) in a model-based form beyond that of the message set and the Link 16 technology. The partitioning of the specification components for J-Messages, J-Words, and J-Fields is simply to avoid a cluttered model.

The Message Specifications namespace provides a home for the concept of a Specification, the Specification identifies the source file from which it is populated (the relevant APIS document) and also references the base standard (from which the APIS has been derived).

The Link 16 Specifications Model provides a point of future extension to support various aspects relevant to Link 16 Specifications (APIS models) and interoperability; current embodiments support the specification of components related to the implementation of a message catalogue via the packages JMessageSpecifications, JWordSpecifications, JFieldSpecifications.

The J-Message Specifications model extends the J-Message and SubLabel concepts introduced by the modelling of the base standard and described below and identifies the relevant transmit/receive characteristics (see FIG. 17).

The J-Word Specifications model extends the J-Word concept introduced below via the SpecifiedWord class. We also extend each of the concrete J-Word types via the classes SpecifiedInitialWord, SpecifiedExtensionWord and SpecifiedContinuationWord; this allows the concrete classes to inherit both the attributes of the concrete J-Word classes and also inherit the transmit/receive attributes from the SpecifiedWordclass.

The J-Field Specifications model extends the Field concept introduced below with the class SpecifiedField and introduces the transmit/receive characteristics relevant to fields within J-Words. A complexity introduced by the APIS is the requirement to be able to model the aliasing of values (DIs) supported by fields (DFI/DUIs) via alternative values (e.g. a platform's APIS may state that whist it receives the field DFI/DUI 270/007 with the value (DI) equal to 2 it will behave as if it had received the filed with the value of 1. Similarly, a platform's APIS may make a similar statement with regard to values (DIs) transmitted. Hence, the concepts Alias and ValueImplementation with the necessary transmit/receive characteristics are introduced.

Embodiments therefore include the parsers and models that provide the capability to capture the components of a platform APIS relating to the message catalogue and are able to link this to the base standard. FIG. 20 provides an illustration of a fragment of an APIS captured from an air platform. In this screenshot it can be seen that field DFI/DUI 843/007 in J-Word J0.0E0 has been declared as transmitting and receiving DI values 1.5 (Illegal) as DI value 0 (No Statement), modelled via an alias element. Also illustrated is the constraining of the field DFI/DUI 756/057 in J-Word J0.1I to the alias value 0; the transmit/receive characteristics of the latter field imply that the field will be set to zero in any transmission of this J-Word, and that it's value will not be processed in any reception of this J-Word.

The fields that comprise each J-Word relate primarily to tactical data; however, some fields are used for “housekeeping”, such as identifying the J-Word type and index. There is some variability in the style with which such fields are captured by various projects, some projects identify all implemented fields in the APIS, other treat such “housekeeping” fields as implicit (since the terminal wouldn't operate without them). In order to avoid the identification of false interoperability issues if we find that such “housekeeping” fields have been omitted we extract the relevant data from the base standard to provide a fully enumerated APIS.

After modelling and capturing the message components of a platform's APIS and providing linkage back to the base standard, the next step is to use these instantiated models to perform a mechanistic interoperability analysis. It should be noted that, prior to the deployment of this tool, the task was undertaken manually and could take a significant period of time to complete, such is the volume of data that must be assessed; the tool is able to perform this activity in a matter of minutes. The interoperability analysis activity is performed by selecting the APIS models of the transmitting and receiving platforms; this could be two different platforms or the same platform, the latter case would be adopted to perform “own-ship” interoperability analysis (e.g. to establish the interoperability of two platforms of the same type). Having identified the transmitting and receiving platforms the message structures are traversed and the transmit characteristics of one model instance are compared against the receive characteristics of the other model instance, in effect asking the question: Can platform A send data item X to platform B? This question can have a number of subtleties, since platform A may be capable of transmitting a data item that cannot be received by platform B, and platform B may be capable of receiving a data item that cannot be transmitted by platform A, platform A may be capable of transmitting a data item that platform B receives but interprets (aliases) as a different data item, finally platform A may be capable of transmitting a data item that platform B receives but does to process. Furthermore, it is prudent to define what is meant by “interoperable” in the context of two J-Messages, SubLabels, J-Words, and Fields.

The interoperability analysis component can be implemented using both the XMF tool and also the Epsilon plugin for Eclipse; hence, the method is not dependant upon a specific technology. The examples herein are taken from the Epsilon-based implementation; however, the basic design is similar in both cases. The Epsilon plugin provides the Epsilon Comparison Language (ECL) to support the comparison of models in accordance with user-defined criteria. In the example of FIG. 21 the comparison of two objects of type SpecifiedMessage (see FIG. 17 for the definition of this class) is illustrated. In the example ECL performs a pattern match to identify instances of type SpecifiedMessage, one from the model Left (platform A), and one from the model Right (platform B) (lines 7 & 8), the guard condition (line 9) ensures that only instances of the same message number are compared, this test is implemented in the operation is Comparable( ), the is Comparable( ) operation is implemented for all object types to be compared, SpecifiedSubLabel, SpecifiedInitialWord, etc. Lines 10 to 13 perform the comparison, the result of which is stored in an ECL-specific construct called matchTrace.

There are two main points to note from the example ECL comparison rule illustrated by the code extract below. Firstly, the operation is Comparable( ) is defined to identify when it makes sense to compare two objects of the same type (e.g. it would be meaningless to compare message J0.0I with message J0.0E0), and, secondly, what is meant by “interoperable” is defined in the body of the compare clause (lines 11 & 12). In this example, two messages of the same type are defined to be interoperable at the message level if the transmitting platform is able to transmit the message and the receiving platform is able to receive the same message, in the case of objects of type SpecifiedMessage this is indicated by the txCode of the transmitting platform's message being set to ‘T’ and the rxCode of the receiving platform's message being set to ‘R’ (see screenshot in FIG. 20). When two messages are considered interoperable at the message level it means simply that one platform is able to transmit the message and the other is able to receive the same message. For a more detailed view, similar comparison rules support the interoperability analysis at the field and data item levels such that a message's interoperability can be resolved to the level of the values that may be transmitted and received within individual fields, and this can provide a view of message-level interoperability at the highest level of fidelity possible. The most significant differences between the comparison rules used to compare objects of the various types are the implementations of the isComparable( ) operation and the actual definition of object interoperability. The Epsilon ECL engine differs from the XMF implementation insofar as it uses a simple pattern matching approach to identifying objects to be compared (it is not structurally-aware), hence it will try to match (e.g.) an instance of a SpecifiedMessage from the model of the transmitting platform's APIS against all instances of SpecifiedMessage from the model of the receiving platform's APIS, hence the isComparable ( ) operation must be provided to identify only those objects that should be compared, since there are multiple instances of the same DFI/DUI utilised in multiple messages we need to ensure that the isComparable ( ) operation identifies the correct instances for comparison, this is achieved via navigation of the links (associations) from (e.g.) the DFI/DUI up to the owning J-Message, an example is illustrated using the operation isComparable ( ) on the class Specified Field in the extract below:

1 - operation SpecifiedField
2 - isComparableWith(other : SpecifiedField) : Boolean {
3 - return self.dfi = other.dfi and
4 - self.dui = other.dui and
5 - self.msb = other.msb and
6 - self.lsb = other.lsb and
7 - self.word.isComparableWith(other.word);
8 - }

The example above determines that two SpecifiedField objects are comparable if both the receiver (the object self) and other have the same value of dfi and dui (lines 3 & 4) and are located at the same position within the word (line 5 & 6), and both the owning word of the receiver and other are also comparable (line 7).

The definition of object interoperability can be captured in the compare clause of each comparison rule; the comparisons used are enumerated in the table below. However, it is important to note that these rules are flexible such that the definition of interoperability may be changed to meet users' requirements, e.g. two SpecifiedSubLabel objects may be required to declared interoperable if one platform is able to transmit (T) and the other is able to receive (R) or receives for receipt compliance but is not interpreted (NIRC).

| | Object | Transmitter | Receiver |
|---|---|---|---|
| 1. | SpecifiedMessage | T | R |
| 2. | SpecifiedSubLabel | T | R |
| 3. | SpecifiedInitialWord | NA | NA |
| 4. | SpecifiedExtensionWord | NA | NA |
| 5. | SpecifiedContinuationWord | NA | NA |
| 6. | SpecifiedField | T | R |
| 7. | ValueImplementation | T | R |

The result of running the ECL comparison script is a matchTrace object containing the result of each comparison clause executed. The matchTrace object may then be used in conjunction with each of the platform APIS models to generate a results document using a model transformation script; Epsilon provides the Epsilon Transformation Language (ETL); however, there are a number of alternative technologies available (e.g. XMF provides XMap).

The ETL script traverses the transmit model, each node is then used to lookup its comparison result in the matchTrace object and, following the model-based approach, generates a result document component such that the result of the transformation is an instance of a Document Model (see FIG. 22). The Document Model is not specific to the reporting of the IoA results but is, rather, a generic document model that could be used to represent many document structures. FIG. 23 provides an illustration of the matchTrace to Document Model transformation, in this example the transformation creates a Table element within which to hold the results of the Tx to Rx comparison.

It is possible that one platform may define transmit or receive characteristics for some item (message, sub-label, word, field, etc.) whilst the other platform may make no statement at all, once again this will need to identified as an interoperability issue. The XMF-based implementation addressees this issue via a single-pass platform 1 Tx versus platform 2 Rx and platform 2 Tx versus platform 1 Rx comparison engine, whilst in the case of the Epsilon ECL/ETL-based approach this needs to be implemented in the ETL script; in the case of the Epsilon implementation we perform the platform 1 Tx versus platform 2 Rx comparison and then explicitly reverse the platforms to perform the corresponding platform 2 Tx versus platform 1 Rx comparison, although the two implementations differ the end result is the same.

The output of the interoperability comparison can comprise a document, in the case of the Epsilon-based embodiment it is an instance of the Document Model, whilst in the case of the XMF-based embodiment it is an XML document. The next step is to render the results document into a human readable report.

An interoperability analysis document can be generated in the form of an XML document (XMF-based embodiment), or as an instance of a Document Model (Epsilon-based embodiment). Different technologies can be used to render these in human readable forms; in the case of the XML document it can be rendered in HTML via XSLT, in the case of the Document Model instance it can be rendered in HTML via the Epsilon Generation Language (EGL)—both approaches are transformational, corresponding to the model illustrated in FIG. 24.

Both XSLT and EGL can be used as template transformational languages, i.e. to specify a template document rendering for some component and then have the transformation engine populate the template with data from the source document. A simple example document transformation taken from one of the EGL templates is illustrated below:

1 - [% if (a.isKindOf(Person)) { %]
2 - <address>
3 - <a
href=“mailto:[%=a.eMailAddress%]”>[%=a.initials%]
[%=a.surname%]</a><br/>
4 - </address>
5 - [% } else if (a.isKindOf(Organisation)) { %]
6 - <address>
7 - [%=a.name%]<br/>
8 - [% for (address in a.address) { %]
9 - [% for (l in address.addressLines) { %]
10 - [%=l.line%]<br/>
11 - [% } %]
12 - [%=address.town%]<br/>
13 - [%=address.county%]<br/>
14 - [%=address.postCode%]<br/>
15 - [%=address.country%]<br/>
16 - [% } %]
17 - </address>
18 - [% } else { %]
19 - <h4>Anonymous</h4>
20 - [% } %]

The example EGL script is one component in a number of scripts and relates to the generation of an address section for a rendering of the Document Model in HTML. The script provides two styles of address: the first at lines 2 to 4 renders an author's name and provides a link to their e-mail address; the second at lines 7 to 17 provides and organisation's address. The script contains template HTML structures, e.g. the <address> . . . </address> tags, and populates these with data extracted from the document model, [%=a.eMailAddress %] extracts the value of the attribute eMailAddress from the Person object which is a subclass of Author (see FIG. 22). An example of the rendered interoperability analysis report generated by EGL is shown in FIG. 25; this report indicates that the J-Word J0.2I is interoperable because both Platform A and Platform B provide the same statement ‘NA’ (platform APIS documents don't always provide interoperability statements at the J-Word level, hence current embodiments declare this situation to be interoperable). Delving into the individual fields of word J0.2I, it can be found that it contains two issues, both DFI/DUI 756/003 and 756/004 are not interoperable because Platform A transmits the field but Platform B does not process it (since these DFI/DUIs relate to “spare” fields this situation would not be considered an interoperability issue for the platforms). The final table of the interoperability analysis report indicates that sub-label J0.3 is not interoperable because Platform A doesn't transmit is, but Platform B can receive it; this would prompt the TDL engineer to confirm whether or not this presented a problem.

For completeness, FIG. 26 provides a screenshot of the interoperability analysis report generated by the XMF-based implementation and rendered via XSLT into HTML. The document fragment indicates the incompatibility of Tx/Rx attributes relating to DFI/DUI 756/003 in J0.2I.

The embodiments described herein provide a model-based approach to a problem affecting a number of TDL programmes. A number of models have been developed from an analysis of the source material including the Link 16 standard and the project-specific APIS documents. A generalised metamodel describing the message catalogue entities relevant to the APIS has been designed such that each project could map its APIS message catalogue specifications into this common format by way of a project-specific parser (e.g. parsers operating on DOORS, MS Excel™ and MS Word™ based project documentation). A metamodel typically comprises a precise definition of the constructs and rules needed for creating semantic models. The metamodel can underpin the model by defining some domain of relevance and constraining the scope of those models that are declared valid within this domain. A metamodel may be used to attach semantics to a model, such that not only are the concepts to be modelled described, but also their meaning. The metamodels used in embodiments of the present system will normally be executable, such that models (instances of the metamodels) may be checked by a suitable tool for validity against the metamodel. A metamodel may be considered analogous to the schema used to define the structure of a database in terms of the entities and relations. Embodiments provide an interoperability analysis algorithm and illustrated examples operate via two distinct implementation technologies that support the automatic comparison of the message catalogue parts of the APIS for any two platforms, or two instances of the same platform for ‘own-ship’ analyses). The transformation and rendering of the interoperability analysis can result in a human-readable document.

The highly modular model-based approach of the embodiments described herein support extension and variation such that the characteristics of additional links, e.g. Variable Message Format (VMF), could be accommodated, as could output in differing formats, e.g. report generation into a DOORS formal module. Some embodiments of the method can determine interoperability of TDL-based characteristics other than messages, e.g. interoperability of the timeslots of the first and second platforms. In practice, the XMF-based version of the tool has been found to provide a significant productivity increase; reducing the time taken to perform an interoperability analysis from, in the region of, a number of man-months to a few minutes.

1-15. (canceled)

16. A method of assessing message interoperability between a first platform and a second platform communicating over a Tactical Data Link (TDL), the method comprising:
obtaining first platform model data representing platform-specific message transmit/receive information over the TDL for the first platform;
obtaining second platform model data representing platform-specific message transmit/receive information over the TDL for the second platform; and
assessing, base on the first platform model data and the second platform model data, message interoperability between the first platform and the second platform.

17. A method according to claim 16, comprising:
checking, based on the first and the second platform model data, whether the second platform is capable of receiving at least one message type sent by the first platform in order to determine interoperability.

18. A method according to claim 17, wherein:
the first platform model data specifies a set of message types, with at least some of the message types each having an associated Data Field Identifier (DFI)/Data Use Identifier (DUI) and zero or more associated Data Items (DIs);
the second platform model data specifies a set of message types, with at least some of the message types each having an associated (DFI)/(DUI) and zero or more Data Items (DIs); and
wherein the checking of whether the second platform is capable of receiving the message type sent by the first platform includes checking whether the associated DFI/DUI and DIs of said message type have matching transmit/receive characteristics in the first and the second platform model data.

19. A method according to claim 16, comprising:
creating the first platform model data and the second platform model data using information derived from at least part of a standards document relating to the TDL.

20. A method according to claim 19, wherein the creating comprising:
parsing at least part of the standards document to produce at least one model template based on the TDL standards document.

21. A method according to claim 20, wherein the model template comprises an executable model.

22. A method according to claim 20, comprising:
analysing implementation documents, relating to the first and the second platforms; and
creating, based on an extension to the model template, the model data for the first and the second platform based on the analysis of the implementation documents.

23. A method according to claim 21, comprising:
analysing implementation documents, relating to the first and the second platforms; and
creating, based on an extension to the model template, the model data for the first and the second platform based on the analysis of the implementation documents.

24. A method according to claim 19, wherein the TDL standards document comprises a Link 16 Standard document.

25. A method according to claim 19, comprising:
deriving message information in the model template is derived from at least part of a Data Dictionary portion of the standards document.

26. A method according to claim 22, comprising:
deriving message information in the model template from at least part of a Message Catalogue portion of the standards document.

27. A method of assessing message interoperability between a first platform and a second platform communicating over a Tactical Data Link (TDL), the method comprising:
creating first platform model data representing platform-specific message transmit/receive information over the TDL for the first platform using information derived from at least part of a standards document relating to the TDL;
creating second platform model data representing platform-specific message transmit/receive information over the TDL for the second platform using information derived from at least part of a standards document relating to the TDL, wherein the creating of the first and second platform model data includes parsing at least part of the standards document to produce at least one model template based on to the TDL standards document;
analysing implementation documents, relating to the first and the second platforms;
creating based on an extension to the model template, the model data for the first and the second platforms based on the analysis of the implementation documents, wherein message information in the model template is derived from at least part of a Data Dictionary portion of the standards document and message transmit/receive information in the first platform model data and the second platform model data is derived from a J-Message transmit/receive portion of the implementation documents; and
using the first and second platform model data to assess message interoperability between the first platform and the second platform.

28. A method according to claim 27, wherein the message transmit/receive information associates DFI and/or DUI data with a message type.

29. A system configured to execute a method according to claim 16.

30. A system according to claim 29, located onboard and in combination with a platform configured to communicate over the TDL.

31. A non-transitory computer program element comprising:
code to cause a computer to execute a method according to claim 16.

32. A method according to claim 17, comprising:
creating the first platform model data and the second platform model data using information derived from at least part of a standards document relating to the TDL.

33. A method according to claim 20, comprising:
analysing an Actual Platform Implementation Specification (APIS) as implementation documents relating to the first and the second platform; and
creating, based on an extension to the model template the model data for the first and the second platform based on the analysis of the implementation documents.

34. A method according to claim 21, comprising:
creating the first platform model data and the second platform model data using information derived from at least part of a standards document relating to the TDL.

35. A method according to claim 23, comprising:
delivering message information in the model template from at least part of a Data Dictionary portion of the standards document.
